(19) United States
(12) Patent Application Publication
(10) Pub. No.: US 2023/0031762 A1
(43) Pub. Date: Feb. 2, 2023

(54) Cryptoanchor Reader

(71) Applicant: Lexmark International, Inc., Lexington, KY (US)

(72) Inventors: SCOTT RICHARD CASTLE, LEXINGTON, KY (US); TRISTAN SANTOS DALAY, MANDAUE CITY (PH); ROBERT HENRY MUYSKENS, LEXINGTON, KY (US); NEILSON GUTAY NAVARRETE, MANDAUE CITY (PH); BRANT DENNIS NYSTROM, LEXINGTON, KY (US); THOMAS EUGENE PANGBURN, WINCHESTER, KY (US); SAMUEL LEO RHODUS, LEXINGTON, KY (US)

(21) Appl. No.: 17/964,479

(22) Filed: Oct. 12, 2022

Related U.S. Application Data
(62) Division of application No. 17/017,086, filed on Sep. 10, 2020, now abandoned.
(60) Provisional application No. 62/898,348, filed on Sep. 10, 2019.

(51) Int. Cl. H04L 9/32; H04W 12/03

(52) U.S. Cl. CPC H04L 9/3234; H04W 12/03; H04L 9/3278

(57) ABSTRACT

Unique Physical Unclonable (PUF) function objects may be created by molding or extruding specialized particles creating a measurable physical characteristic over a surface. The magnetized particles form a unique measurable magnetic “fingerprint” based on the random size, position, polar rotation, magnetization level, particle density, etc., of the particles. PUF objects may also vary in other physical characteristics by having a mixture of magnetic, conductive (magnetic or nonmagnetic), optically reflective or shaped, varied densities or mechanical properties resulting in random reflection, diffusion, or absorption of acoustical energy particles in a matrix or binder. The present invention envisions sensing any of the characteristics.

### CROSS REFERENCES TO RELATED APPLICATIONS

This application is a divisional application of U.S. patent application Ser. No. 17/017,086, filed Sep. 10, 2020, titled “CryptoAnchor Reader,” which is related to and claims priority as a continuation of under 35 U.S.C. 119(e) from U.S. Prov. App. No. 62/898,348, filed Sep. 10, 2019, titled “CryptoAnchor Reader,” the content of which is hereby incorporated by reference herein in its entirety.

### BACKGROUND

The present disclosure relates generally to devices for capturing physically measurable characteristic of physical unclonable function objects created by molding specialized particles into a resin or matrix.

### SUMMARY

Unique Physical Unclonable (PUF) function objects may be created by molding or extruding specialized particles creating a measurable physical characteristic over a surface. The PUF may be pre-magnetized or post-magnetized particles into a resin or matrix. The pre-magnetized particles form a unique measurable magnetic “fingerprint” based on the random size, position, polar rotation, magnetization level, particle density, etc., of the particles. PUF objects may also vary in other physical characteristics by having a mixture of magnetic, conductive (magnetic or nonmagnetic), optically reflective or shaped, varied densities or mechanical properties resulting in random reflection, diffusion, or absorption of acoustical energy particles in a matrix or binder. The present invention envisions sensing any of the characteristics.

### BRIEF DESCRIPTION OF THE DRAWINGS

The above-mentioned and other features and advantages of the disclosed embodiments, and the manner of attaining them, will become more apparent and will be better understood by reference to the following description of the disclosed embodiments in conjunction with the accompanying drawings.

FIG. 1 shows possible optical responses to a high entropy taggant.

FIG. 2 shows an example of real-time, raw 3-axis magnetometer reported by iOS.

FIGS. 3A, 3B, 4A, 4B, 5A, and 5B show hand-held reader devices.

FIG. 6 shows a wrist or forearm reader device.

FIGS. 7A, 7B, and 7C show a rotatable reader design with a plurality of magnetometers.

FIGS. 8 and 9 show a sensory array or CMOS array.

FIGS. 10A and 10B show embodiments using a native mobile phone device.

FIGS. 11A-C, 12A-B, and 13A-B, 14A-C, 15A-B, and 16 show reader designs that are worn or held by the user.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having,” and variations thereof herein is meant to encompass the items listed thereafter and equivalents thereof as well as additional items.

Terms such as “about” and the like have a contextual meaning, are used to describe various characteristics of an object, and such terms have their ordinary and customary meaning to persons of ordinary skill in the pertinent art. Terms such as “about” and the like, in a first context mean “approximately” to an extent as understood by persons of ordinary skill in the pertinent art; and, in a second context, are used to describe various characteristics of an object, and in such second context mean “within a small percentage of” as understood by persons of ordinary skill in the pertinent art.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Spatially relative terms such as “top,” “bottom,” “front,” “back,” “rear,” and “side,” “under,” “below,” “lower,” “over,” “upper,” and the like, are used for ease of description to explain the positioning of one element relative to a second element. These terms are intended to encompass different orientations of the device in addition to different orientations than those depicted in the figures. Further, terms such as “first,” “second,” and the like, are also used to describe various elements, regions, sections, etc., and are also not intended to be limiting. Like terms refer to like elements throughout the description.

This invention captures novel concepts related to a “Crypt® Anchor” reader, i.e., the element that can sense the contents of a CryptoAnchor and submit data for authentication. The reader may exist in multiple forms and employ more than one sensing type simultaneously. The first embodiment of a “Crypt® Anchor” is that of pre-magnetized particles suspended in a polymer binder. The reader would have a plurality of magnetic sensing elements in an array.

The magnetic sensing array is composed of discrete, three-axis Hall Effect devices mounted to a printed circuit board (PCB) as closely as allowable by the chip package. A limitation of this approach is the low spatial density of sensors achievable. An integrated sensor array that has very high spatial density compared to discrete chips on PCB and sensing element near surface may be preferable. A magneto-optical feature may also be desirable.

While there exist techniques for measuring magnetic fields, the CryptoAnchor tag is intended to create magnetic fields with an absolute value of typically between 0 and 100 Gauss. The reader is not intended to perform authentication, but to sense characteristics and communicate the measured information to another device that calculates comparison. The results of the comparison may then be displayed on the reader. The communication methods could be wired (e.g., Ethernet) or wireless (e.g., WiFi, Cellular).

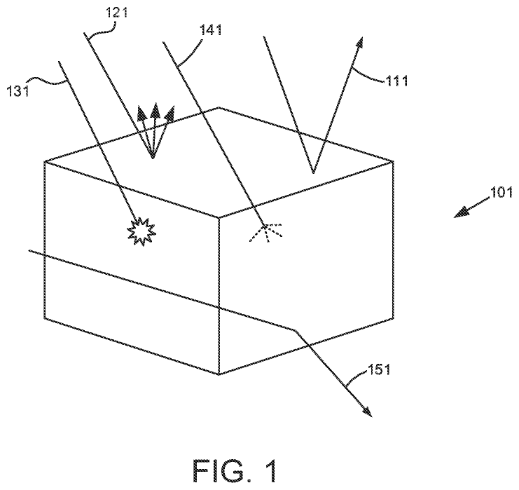

In addition to the magnetic characteristics, depth and layering of high entropy taggants provides more degrees of freedom (DOF) to be measured to assure authenticity. For example, higher DOF enables more customization of tag for size, shape, brand, error checking, hashing, uniqueness, clonability, etc. High entropy taggants 101, see FIG. 1, might include, for example, optical properties such as specular reflection 111, diffuse reflection 121, absorption 131, scatter 141, and transmission 151, including, but not limited to human visual. Emerging miniaturized hyperspectral systems may provide additional optical and non-optical sensor options.

High entropy taggants may further include materials that are fluorescent or phosphorescent. Use of these materials is practiced in biological sciences, analytical chemistry, and forensics.

Barcode and radio frequency (RF) are common, growing means to track-and-trace items in a supply chain. Each technology is easily copied but when combined with a plurality of high entropy taggants and means to read each layer independently would enable depth and customization.

The invention described has a magnetic taggant but allows for the strategic architecture of a system to practice a wide variety of taggants, potentially simultaneously, depending on the application. A market example where layering is conspicuous is the paper currency market, where, e.g., the U.S. $100 bill contains approximately twenty different features of overt, covert, and forensic nature.

The U.S. Department of Defense provides an example of authenticity requirements in response to congressionally-mandated service parts authentication improvements that seek a solution to prevent the use of counterfeit integrated circuit (IC) items in DoD equipment. DoD Solution RFQ requires: (1) minimal disruption to existing supply chain; false positive rate of less than 1/10¹²; false negative rate of less than 1/10⁴; authentication in less than 10 sec; area of tag less than 64 mm²; additional IC height less than 1 mm; all data able to be hosted by DoD; cost of the tag less than $50; and cost of the reader less than $50,000.

A solution described here that meets these requirements is an 8×8 mm magneto-optical device over-molded into the chip cap with a reader that simultaneously, but independently, measures the three-axis magnetic signature, encrypts, transmits to a first server over cellular link and captures high resolution RGB/UV image, encrypts, transmits to a second server over Wi-Fi link. A comparison can be made on each server with a logical AND at point of measurement to verify the authenticity of critical integrated circuits.

In a second example, high-end consumer goods makers with exclusive brands seek differentiated authentication solutions to further branding. A solution is to integrate a near-field communication (NFC) tag with magnetic tag into the logo of the branded product. Such NFC tags can be interrogated with mobile phone and a branded application. A branded, magnetic tag reader located conspicuously at point-of-sale, can provide authentication for the consumer.

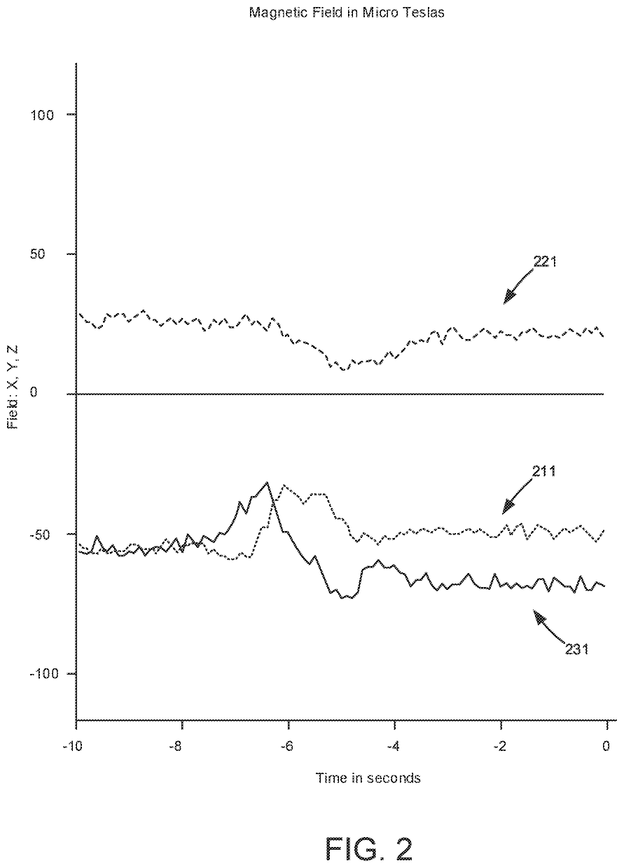

The proliferation of mobile devices, intrinsic sensing, and defined interfaces for peripheral demand enables a reader based around a mobile device. To allow a mobile device to function as a compass, largely used for navigation functions, it must contain a magnetometer. FIG. 2 shows an example of real-time, raw 3-axis magnetometer reported by iOS, with the X-Field 211, Y-Field 221, and Z-Field 231. Mobile devices may have: (1) on the front—RBG camera, infrared (IR) sensor, a structured light projector, and a high pixel density display, that could be used as a light source; (2) on the rear—RGB camera(s), and a flash; and (3) communications capabilities, including—cellular, WiFi, Bluetooth, Bluetooth Enabled, NFC, and RFID.

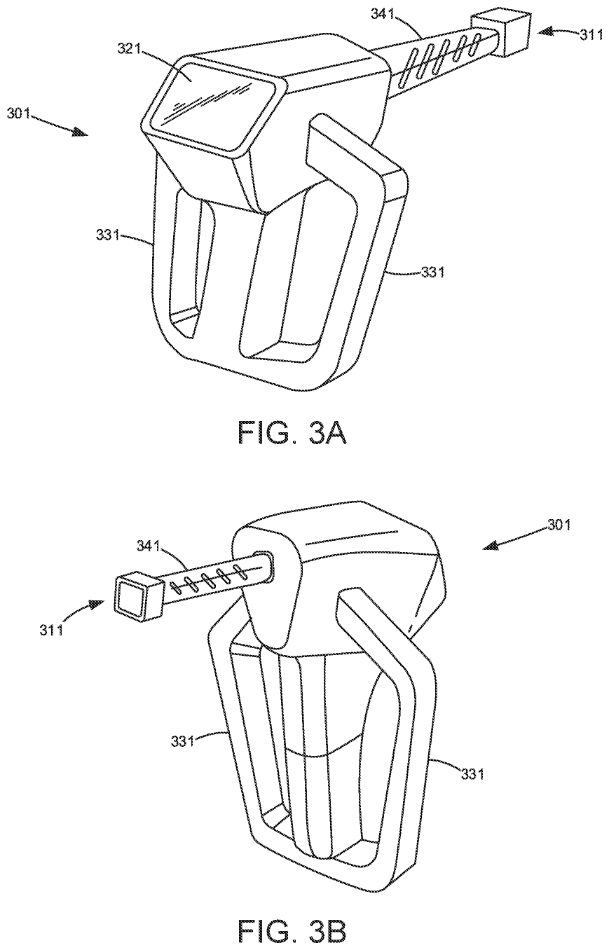

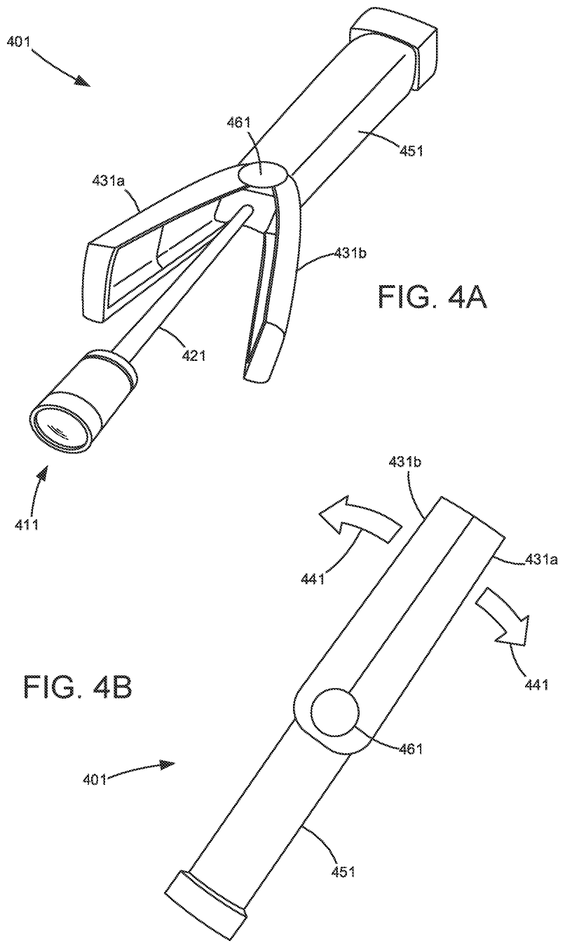

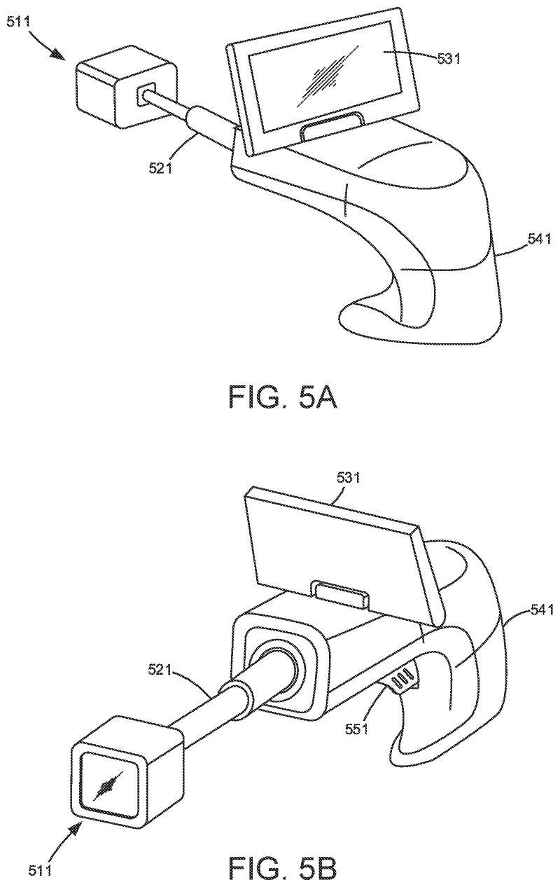

Design incorporating a telescoping read head, mechanized or manual, that extends the useful range for space constrained applications, which may be used with a mobile device are shown in FIGS. 3A, 3B, 4A, 4B, 5A, and 5B. FIGS. 3A and 3B show a hand-held telescoping reader 301, with handle grips 331, a reader 311, and a telescoping unit 341 to support the reader 311. FIGS. 4A and 4B show a hand-held telescoping wand 401, with a reader, also referred to herein as a read-head, 411, a telescoping unit 421, cover elements 431A, and 431B that encase the reader 411 shown in the retracted position in FIG. 4B, and open to allow extension of the reader in FIG. 4A. The cover elements 431A, and 431B may pivot at a point 461 on the handle 451 to open 441. In FIGS. 5A and 5B, a reader on a device with a pistol-grip 541 is shown with a reader 511, a telescoping unit 521, a display 531 that may be a mobile device. The reader 411 is activated by the user with a switch 551. The read-head may contain a camera and/or light source for guiding into location. The read-head may also contain a set of locating features to align a specimen to a camera unit, including mechanical and magnetic means. The read-head could be swapped to measure other unique features including uniqueness of magnetic signature.

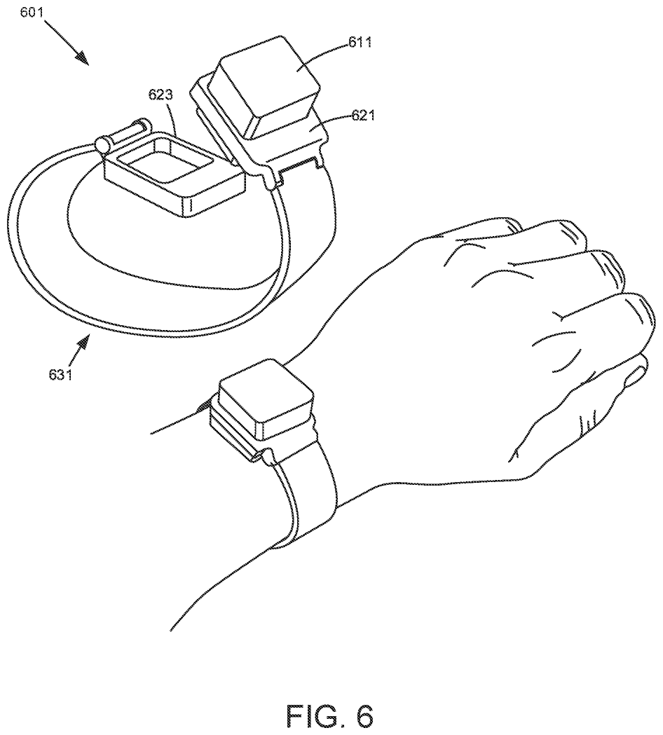

A wrist or forearm reader device 601 for hands free operation is shown in FIG. 6. The reader 611 may be connected through Bluetooth interface 621. A snap to lock attachment 623 and remove with moldable strap 631 that may double as temporary handle.

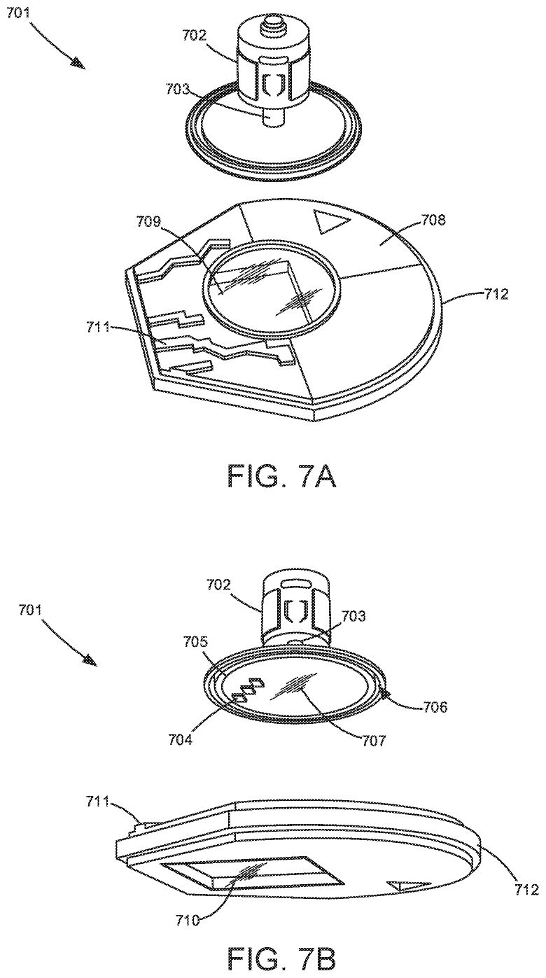

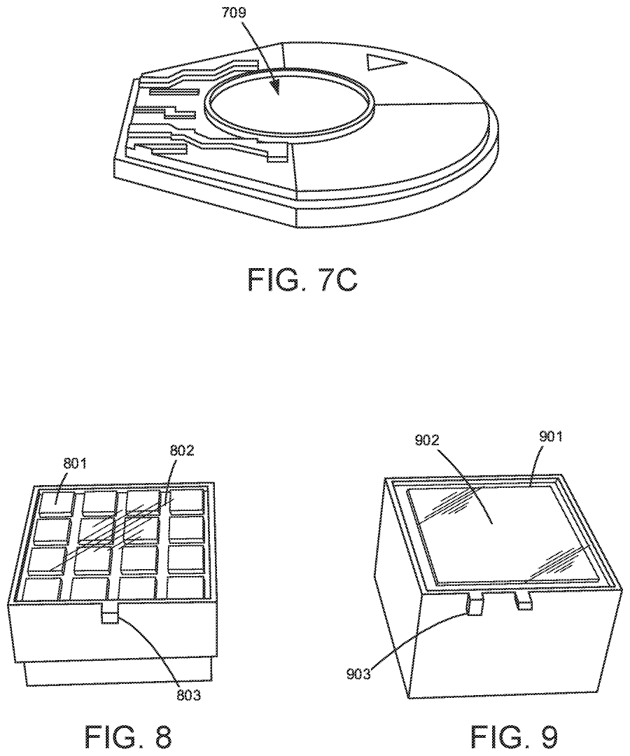

Another embodiment of a reader design is shown in FIGS. 7A, 7B, and 7C. A plurality of rotating magnetometers in an array 704, potentially staggered, to read lanes of pre-magnetized material. The reader head 709 may be moved against a PUF specimen (not shown). The reader head may be held by normal forces, snap-fit, and/or vacuum force and located by simple mechanical features. The features could be paired as chip/reader.

In the embodiment, the rotational position of the reader 701 may be controlled by a motor 702 connected to the reader by a shaft 703. Other elements include a bezel 712, a piezoelectric element 705, a magnetic field camera window 710, a sensor cover 707, a locating feature 706, a faceted optical PUF 708, a key, SD card, or other reader 711. Proximity sensing (not shown) could be incorporated to trigger sensor and feedback to user. An optical camera (not shown) could be included to read barcode and/or capture reference image of tag. Proximity allows for RF (e.g., NFC, RFID) to be energized and be read like a barcode. Rotating sensors could be in contained in a wand, gun or probe form. Sensor could be powered by battery or external with data storage, A/D and communication of wide variety.

The magnetic field lines generated by the magnetic particles in the PUF element are closed, and thus a single field strength sensor (e.g., Bz) moving in a straight line will see the magnitude change as function of distance separation and orthogonality of motion to field line. For example, while one sensor, due to alignment, may read a maximum Bz magnitude, a second sensor may read a minimum based on distance.

An array of sensors that measures at controlled distances above specimen where each reading would be distinct. The controlled distance could be manual or mechanical. In the mechanized case, proximity could be sensed and recorded for each measurement. Here, the motion to and from the PUF specimen would measure unique characteristics of magnetic field structure.

In a modification, shown in FIGS. 8 and 9, a discrete sensor chip 801 or bare complementary metal-oxide-semiconductor (“CMOS”) array 901 may be provided. A cover for circuit protection 802, 902 may be provided, along with keying 801, 901 for orientation and lockout. If symmetric, keyed or without key, the sensor could read in any orientation.

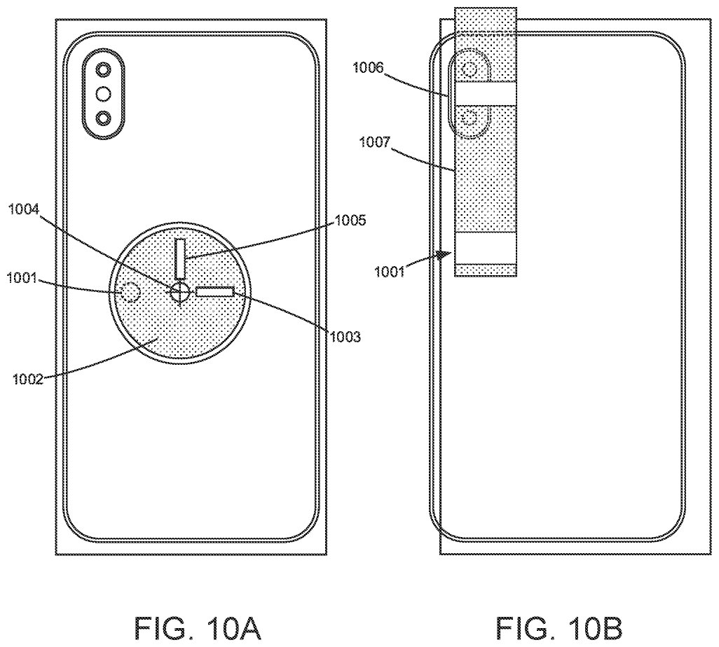

In a further embodiment shown in FIGS. 10A and 10B, methods for using the native mobile device magnetometer 1001 or magnetometer array, potentially staggered, to read PUF elements 1002 is disclosed. A fiducial hole 1003 and fiducial void 1005 may be used for position. A raised fiducial may be used in place of the fiducial void. One device having a pivot 1004 that allows rotation past the magnetometer and a second device 1007 that promotes sliding past the magnetometer. Depending on location of pivot and locating features for sliding. One may use the camera/flash module 1006 as another method to read a PUF tag. This read could also be utilized for velocity or optical data.

Mobile payment methods are growing quickly, so a plurality of sensing provides a means to authenticate prior to purchase. When mobile purchasing is initiated (e.g., ApplePay®), a photo (e.g., object recognition) or RF (e.g., NFC) interrogation of an item under purchase may be made. This step could be made optional and/or required by a device-maker, retailer and/or brand. Levels of authenticity verification required could be function of type/class/price/safety of purchase. Opt-out possible by admin-level user. Valid authentication of item then required to complete purchase.

The mobile device option offers the combination of a magnetometer reading with camera, which can be used for various purposes, and offers the opportunity for authentication verification workflow into mobile payment process. Notably, however, operation would be dependent upon the mobile device, and locating the PUF tag relative to the magnetometer.

Further, the color, brightness, and high resolution of modern mobile device display could be used as the source light to measure a unique optical object. The display could exercise a battery of pattern, brightness, and color. Patterns could be lines, checkboards, concentric circles across any part of specimen surface. Moreover, an engineered light-pipe would transmit light exiting on any and all surfaces back to native camera.

Unique optical objects can include a wide variety of difficult-to-clone embodiments, including but not limited to, speckles, refractive index, occlusions, reflectors, filters, etc., enclosed in transparent medium. Surfaces or optical object could include mirrors, ports, and lenses, to contain and disperse light within transparent medium. Using these unique optical objects, a flash of light could be introduced into a particular location with transmission collected at another location. Internal reflection and absorption will delay in time the transmission from original impulse. Using the optical time domain detection of random internal reflection and absorption, it may be possible to use the native flash of a mobile device as a source.

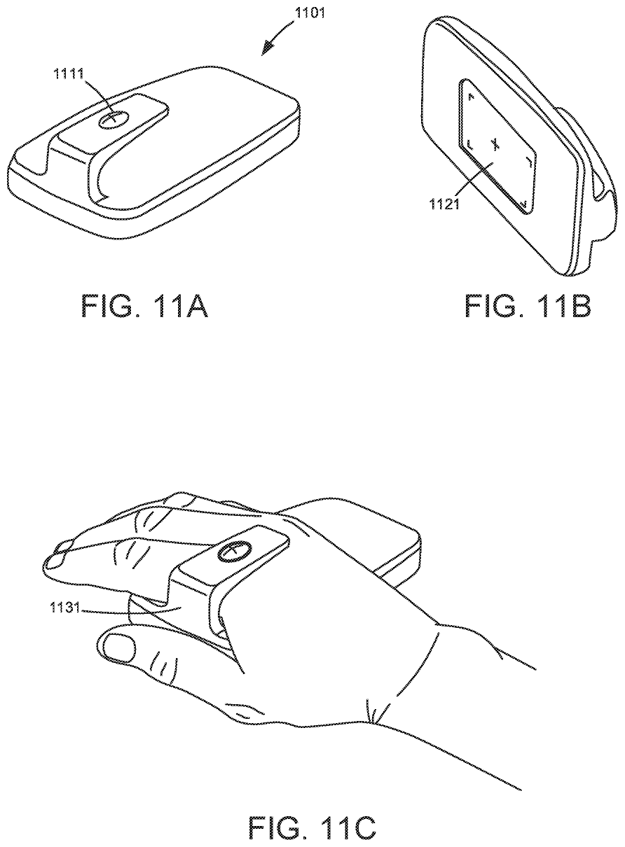

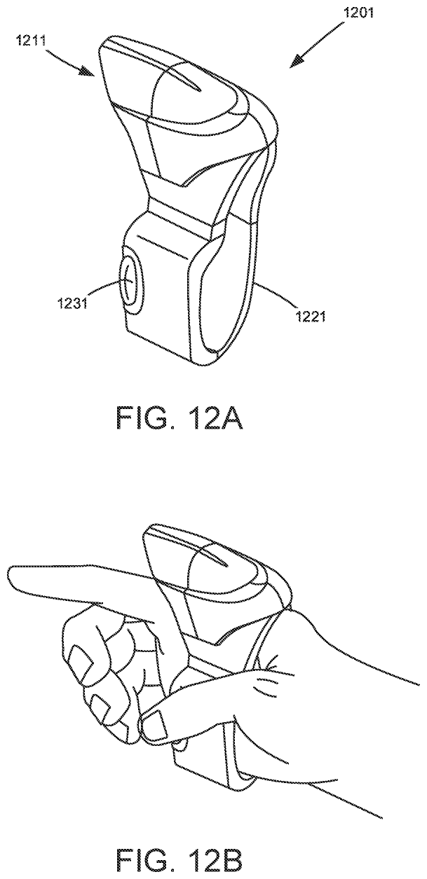

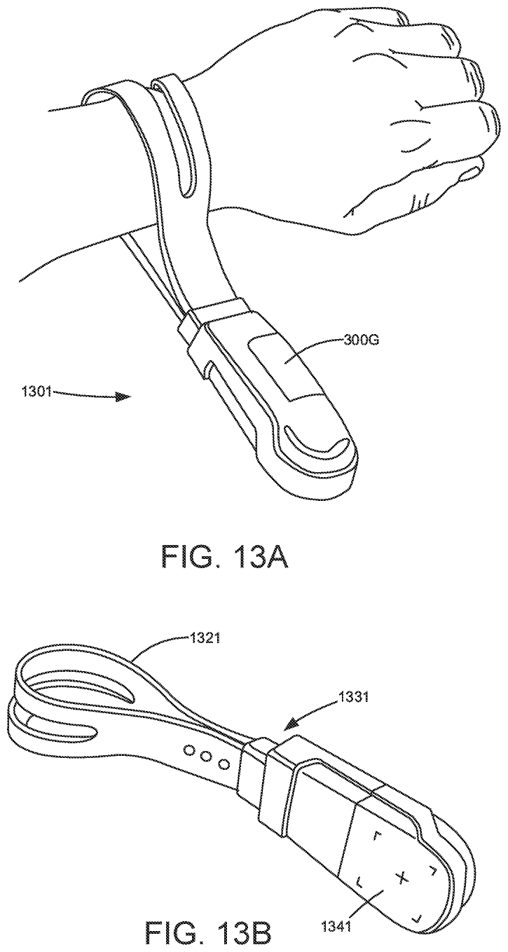

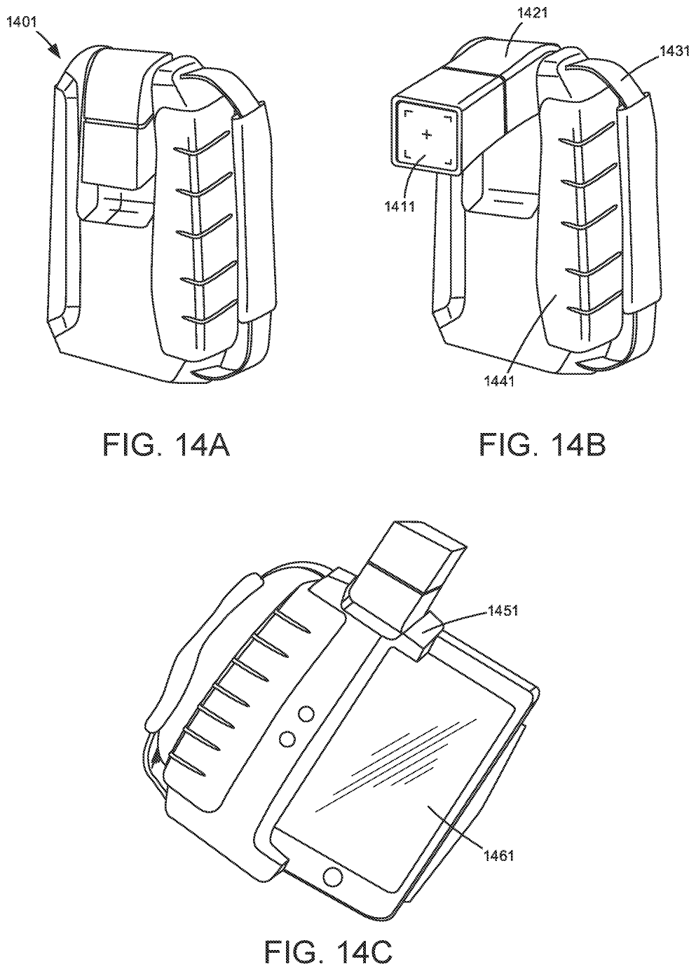

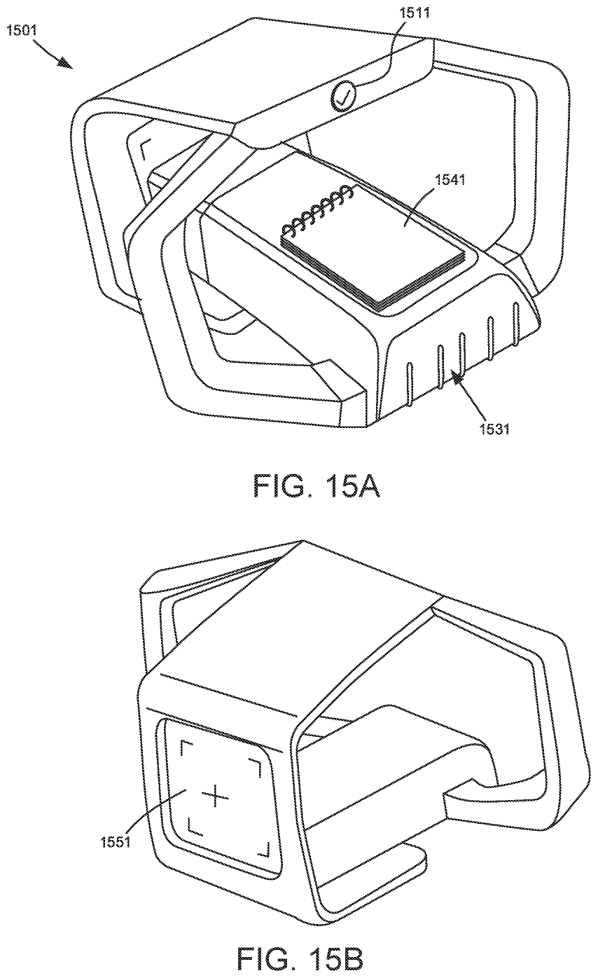

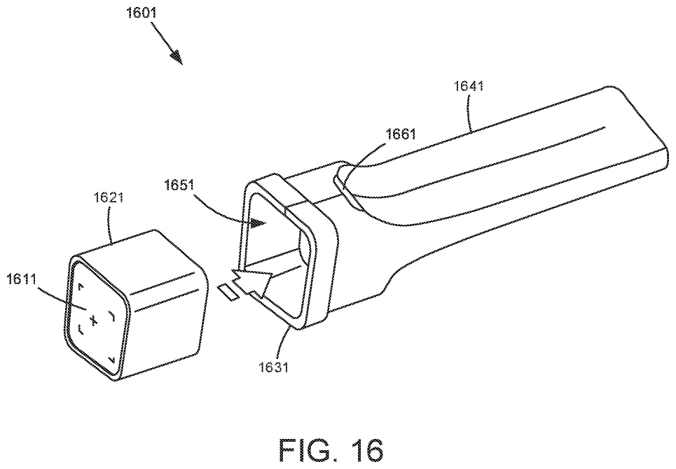

Other reader designs include forms 1101 worn on the hand to improve hand utilization such as in FIGS. 11A, 11B, and 11C. The reader 1101 includes an element to hold the reader on the user's hand 1131, a reader screen 1121, and may have an LED indicator 1111 to indicate operation.

Shown in FIGS. 12A and 12B is another design 1201 that is worn on the user's hand. A strap 1221, preferably flexible, secures the device, with the reader screen 1211 is directed by the user's fingers. The reader may have an LED indicator 1231 to indicate operation.

Shown in FIGS. 13A and 13B is a final design 1301 that is worn on the user's hand. A strap 1321, preferably flexible, secures 1331 the design, with the reader screen 1341 directed by the user's hand. The reader may have an LED indicator 1311 to indicate operation.

A reader is shown in FIGS. 14A, 14B, and 14C with the reader sensor integrated in a mobile tablet case. A modular read head 1411 with option to add the smart phone or tablet 1411 mounted in a receiving bracket 1451. A rotatable reader 1421 is provided for optimal ergonomics and/or read/head protection. A strap 1431, preferably flexible, secures the device.

A two-handed reader 1501 is disclosed in FIGS. 15A and 15B with a large sensing window 1551 and orientation sensing within reader (not shown) to aid in image capture/processing. The two-handed reader 1501 has handles 1521, a support pad 1531, and an optional work-space area 1541.

Finally, a hand-held device 1601 is disclosed with a reader module 1611 that snap locks into a receiver 1651 of a stylus 1631 with a grip 1641 for the user's hand. The reader may have an LED indicator 1661 to indicate operation.

We claim:

1. A physical unclonable function reader comprising:
a read-head with an array of sensors that measures at controlled distances above specimen where each reading would be distinct, wherein the controlled distance is mechanical and the proximity to the specimen is sensed and recorded for each measurement;
a camera or light source for guiding the read-head into location; and
locating features to align the specimen to a camera unit.

2. The device of claim 1, wherein the read head is telescoping to extend the useful range for space constrained applications.

3. The device of claim 2, wherein the telescoping is mechanized.

4. The device of claim 1, further comprising:
handle grips;
cover elements that encase the reader in a retracted position and open to allow extension of the reader, wherein the cover elements may pivot at a point on the handle to open.

5. The device of claim 1, wherein the reader device is mounted on the user's forearm or wrist for hands free operation.

6. The device of claim 1, wherein the reader device is worn on the user's hand comprising:
a flexible strap to secure device;
a reader screen directed by the user's fingers; and
an LED indicator to denote operation.

7. The device of claim 1, further wherein the reader sensor device is integrated into a mobile tablet case.

8. The device of claim 1, further wherein the reader device has two handle grips to enable operation by the user.

9. The device of claim 1, further comprising:
a reader module; and
a stylus with a grip for the user, wherein the reader module snap locks into a receiver of the stylus.
